(19) United States
(12) Patent Application Publication
(10) Pub. No.: US 2016/0316040 A1
(43) Pub. Date: Oct. 27, 2016

(54) PROVIDING PIPELINE FOR UNIFIED SERVICE AND CLIENT INTERFACE

(71) Applicant: MICROSOFT TECHNOLOGY LICENSING, LLC, Redmond, WA (US)

(72) Inventors: Sudhi Ramamurthy, Redmond, WA (US); Shaofeng Zhu, Redmond, WA (US); Michael Zlatkovsky, Redmond, WA (US); Robert Howard, Bellevue, WA (US); Gabriel Royer, Redmond, WA (US)

(21) Appl. No.: 14/845,179

(22) Filed: Sep. 3, 2015

Related U.S. Application Data
(60) Provisional application No. 62/153,412, filed on Apr. 27, 2015.

(51) Int. Cl. H04L 29/08; G06T 11/20

(52) U.S. Cl. CPC H04L 67/32; G06T 11/206

(57) ABSTRACT

A pipeline for a unified service and client is provided. An application such as a productivity application constructs a pipeline based on a shared code base with another productivity application. The pipeline facilitates a communication between a client application and an interface of the productivity application. A received client request, by the pipeline, is processed to construct a serialized request. The serialized request is transmitted to the interface of the productivity application. An initial response to the serialized request is received and processed to construct a standardized response. Subsequently, the standardized response is transmitted to the client application.

### CROSS-REFERENCE TO RELATED APPLICATIONS

This Application claims the benefit under 35 U.S.C. §119(e) of U.S. Provisional Patent Application Ser. No. 62/153,412 filed on Apr. 27, 2015. The disclosure of the U.S. Provisional Patent Application is hereby incorporated by reference in its entirety.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications process productivity requests. Productivity applications may present functionality through application interfaces. Platform variances may adversely affect application interface maintenance and development.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a pipeline for a unified service and client interface. In some examples, a productivity application may construct a pipeline based on a shared code base with another productivity application. The pipeline may facilitate a communication between a client application and an interface of the productivity application. A received client request may be processed to construct a serialized request. The serialized request may be transmitted to the interface of the productivity application. An initial response to the serialized request may be received and processed to construct a standardized response. Subsequently, the standardized response may be transmitted to the client application.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating example components of a scheme to provide a pipeline for a unified service and client interface, according to embodiments;

FIG. 2 is a component diagram illustrating a productivity application that provides a pipeline for a unified service and client interface, according to embodiments;

FIG. 3 is a display diagram illustrating an example of processing a client request with a pipeline for a unified service and client interface, according to embodiments;

FIG. 4 is a display diagram illustrating an example of processing a response with a pipeline for a unified service and client interface, according to embodiments;

FIG. 5 is a simplified networked environment, where a system according to embodiments may be implemented;

FIG. 6 is a block diagram of an example computing device, which may be used to provide a pipeline for a unified service and client interface; and

FIG. 7 is a logic flow diagram illustrating a process for providing a pipeline for a unified service and client interface, according to embodiments.

### DETAILED DESCRIPTION

As briefly described above, a pipeline for a unified service and client interface may be provided by a productivity application. The productivity application may construct a pipeline based on a shared code base. The pipeline may facilitate a communication between a client application and an interface of the productivity application. The pipeline may receive a client request and process the client request to construct a serialized request. A serialization scheme may be applied to the client request to remove platform specific instructions from the client request.

The serialized request may be transmitted to the interface of the productivity application. Next, an initial response to the serialized request may be received from the interface of the productivity application. The initial response may be processed to construct a standardized response. The initial response may be processed with a standard to generate the standardized response. Standardized instructions may allow the initial response to be interpreted by the client application. Subsequently, the standardized response may be transmitted to the client application.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to provide a pipeline for a unified service and client interface. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

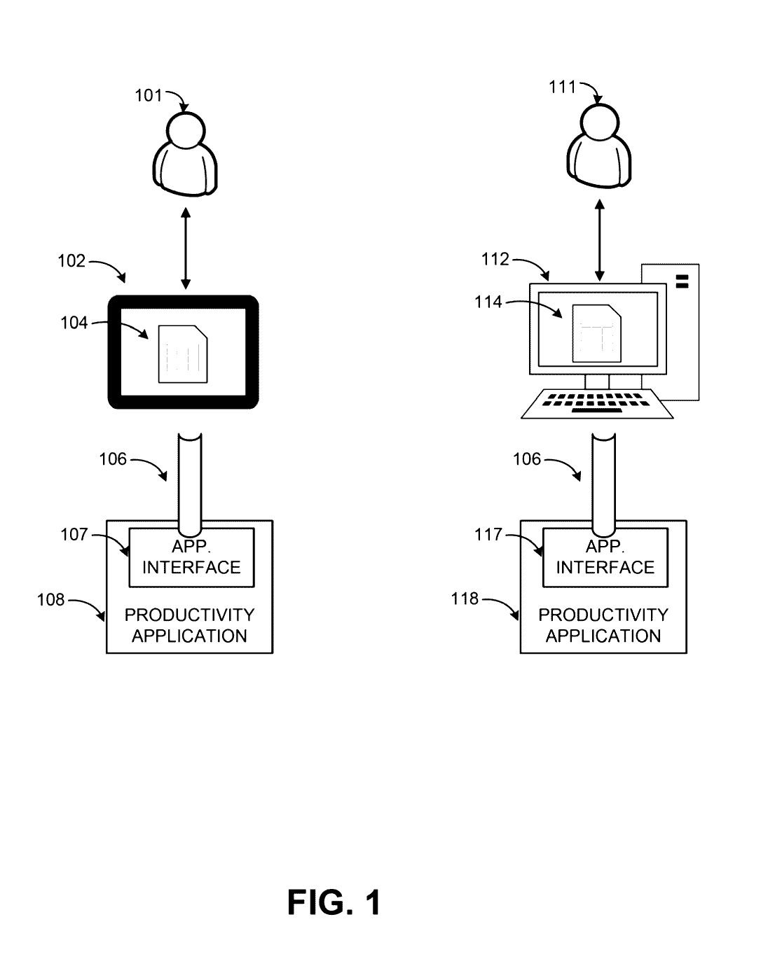

FIG. 1 is a conceptual diagram illustrating example components of a scheme to provide a pipeline for a unified service and client interface, according to embodiments.

In a diagram 100, a computing device 102 may execute a client application 104. The computing device 102 may include a tablet device, a laptop computer, a desktop computer, and a smart phone, among others. The computing device 102 may display the client application 104 to a user 101. The user 101 may be allowed to interact with the client application 104 through an input device or touch enabled display component of the computing device 102. The computing device 102 may include a display device such as the touch enabled display component, and a monitor, among others to provide the client application 104 to the user 101.

The client application may interact with a productivity application 108 through a pipeline 106. The productivity application 108 may be executed by the computing device 102 or another computing device such as a physical server. The pipeline 106 may provide a communication channel between the client application 104 and an application interface 107 of the productivity application 108. The communication channel may be necessary to remove platform specific instructions between the client application 104 and the productivity application 108.

The pipeline 106 may be constructed by a shared code base of the productivity application 108 to extract and serialize platform specific instructions within a client request from the client application 104. A serialization scheme may remove platform specific instructions and allow an application interface 107 to process the serialized instructions. As such, the pipeline may work as an abstraction layer between the client application 104 and the application interface 107. The application interface 107 may be custom constructed to access complex features of the productivity application 108.

In an example scenario, the user 101 may provide platform specific instructions to the client interface to execute the instructions at the productivity application 108. The pipeline may serialize the client request and transmit the request to the application interface 107. The productivity application may process the serialized instructions and transmit a response through the application interface 107. The response may be standardized by the pipeline 106 to a standard format that may be interpreted by the client application 104. The standardized response may be delivered to the client application 104.

The pipeline 106 may be used as a communication channel between the productivity application 118 and the client application 114 because of the shared code base between the productivity application 108 and the productivity application 118. The shared code base may be used to construct the pipeline 106. Although an execution platform of the productivity application 118 may differ from the execution platform of the productivity application 108, the productivity application 118 may use the pipeline 106 to communicate with the client application 114.

For example, a user 111 may instruct the client application 114 executing on the client device 112 to transmit a request to the productivity application 118. The request may be transmitted through the pipeline 106 and provided to the application interface 117 after removal of platform specific instructions. The application interface 117 may transmit a response through the pipeline 106. The pipeline 106 may reconstruct the response to a standardized response that the client application 114 may interpret.

Examples of the client application 104 and the productivity application 108 may include a web browser and a spreadsheet processing application, respectively. Examples of the client application 114 and the productivity application 118 may include a user interface application and a data store processing application

The user 101 may interact with the client application 104 with a keyboard based input, a mouse based input, a voice based input, a pen based input, and a gesture based input, among others. The gesture based input may include one or more touch based actions such as a touch action, a swipe action, and a combination of each, among others.

The computing devices (102 and 112) may communicate with execution platforms of the productivity applications (108 and 118), respectively, through a network. The network may provide wired or wireless communications between nodes such as the computing devices (102 and 104), or execution platforms of the productivity applications (108 and 118), among others.

While the example system in FIG. 1 has been described with specific components including the computing devices (102 and 112), the productivity applications (108 and 118), and the client applications (104 and 114), embodiments are not limited to these components or system configurations and can be implemented with other system configuration employing fewer or additional components.

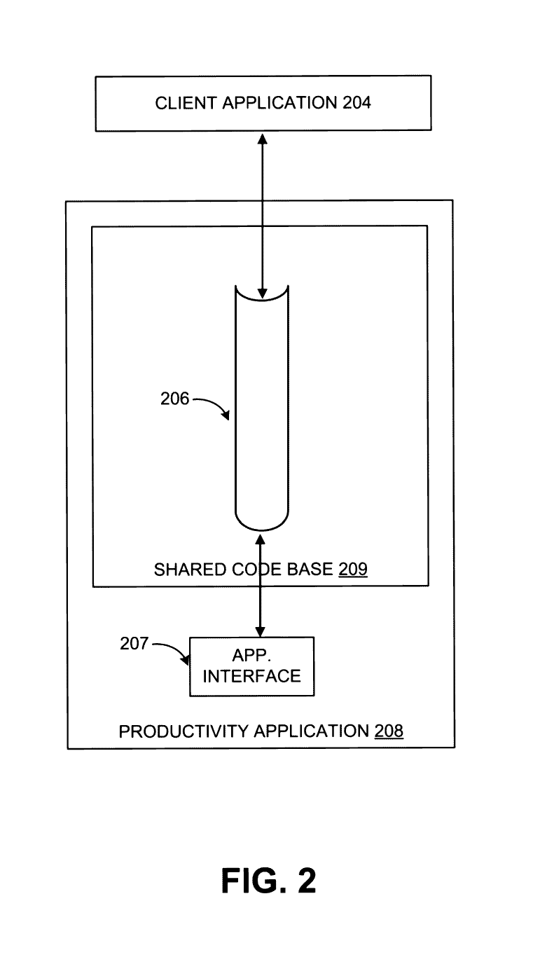

FIG. 2 is a component diagram illustrating a productivity application that provides a pipeline for a unified service and client interface, according to embodiments.

In a diagram 200, a productivity application 208 may construct a pipeline 206 from a shared code base 209. The shared code base 209 may be distributed across similar productivity applications that are customized for a variety of platforms such as a desktop environment, a mobile environment, or a web based environment, among others. An example of a shared code base may include a programming library package used to build customized tools.

The pipeline 206 may act as an interface between an application interface 207 and a client application 204. The application interface 207 may provide access to a large number of features of the productivity application 208 that may necessitate a high level of complex programming to optimally utilize. The pipeline 206 may remove platform specific instructions in incoming instructions from the client application 204. As such, a need to provide a platform specific application interface to communicate with the client application 204 may also be rendered unnecessary.

The pipeline 206 may standardize the response from the application interface 207 using a standard that may be interpreted by the client application 204. As such, a variety of platform specific client applications may be able to communicate with the productivity application 208 through the pipeline 206.

The pipeline 206 may be constructed and executed during an execution of the productivity application 208. The pipeline 206 may also be shared with other productivity applications to allow the application interfaces of other productivity applications to communicate with platform specific client applications. The pipeline may also be capable of receiving batch instructions in a client request. The pipeline 206 may process the batch of instructions for asynchronous execution by the productivity application 208.

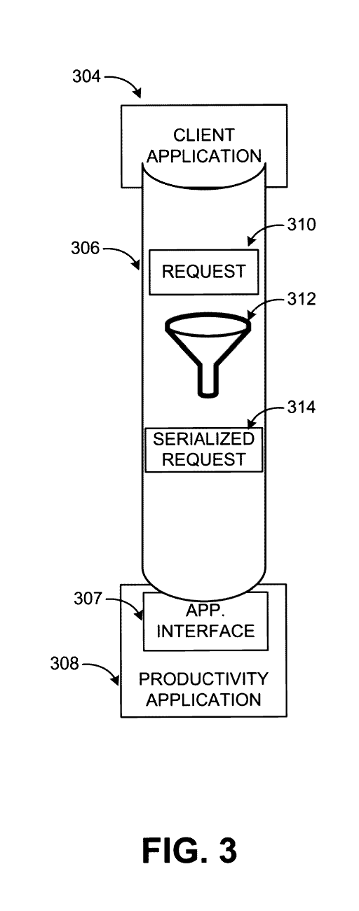

FIG. 3 is a display diagram illustrating an example of processing a client request with a pipeline for a unified service and client interface, according to embodiments.

In a diagram 300, a productivity application 308 may communicate with a client application 304 through a pipeline 306. The pipeline 306 may act as a communication channel between the client application 304 and an application interface 307.

The pipeline 306 may receive a client request 310 from the client application 304. Platform specific instructions within the client request 310 may be removed through a serialization scheme 312 to produce a serialized request 314. The serialized request 314 may be delivered to the application interface 307.

Addresses of local or external sources within the client request may also be processed by the pipeline 306. A convention may be applied to the local or external source addresses to remove a platform specific address from the local or external source addresses. An example of a local source may include a document stored by the productivity application 308. An example of an external source may include a document provided by a content provider such as a web server.

The pipeline 306 may also process the client request 310 to identify asynchronous instructions. Asynchronous instructions may include processes that may be executed at different times. Asynchronous execution may allow the productivity application 308 to utilize fewer resources by distributing the execution of the instructions in the client request 310 across a stretch of time. However, asynchronous execution of the instructions may lead to a delay in generating a response to the client request 310. As such, synchronous execution of the instructions of the client request 310 may be preferable.

The pipeline 306 may generate a thread for each identified asynchronous instruction in the client request 310. The threads may be executed synchronously to remove a possibility of generating the response asynchronously.

Individual load and execution operations within instructions of the client request 310 may also be undesirable. The load and execute statements may conflict as acceptable input by the application interface 307. As such, the pipeline 306 may be configured to filter out load or execute statements.

For example, the pipeline 306 may generate an abstract syntax tree from instructions of the client request 310 to screen for load and execute instructions. The abstract syntax tree may include a tree shaped structure. The tree shaped structure may be a representation of a syntactical construction of the client request 310.

A control flow graph may be generated from the abstract syntax tree. The control flow graph may include probable execution paths of the client request 310. Nodes of the control flow diagram may be processed to identify entities labeled with a load statement or an execution statement. Load statement may cause an execution of a load operation associated with identified instructions during an execution of the client request 310. The execute statement may cause an execution of the identified entities during an execution of the client request 310.

The identified entities in the control flow graph may be annotated to remove the load and execution statements. Next, the serialized request 314 may be constructed from the annotated control flow graph and the abstract syntax tree.

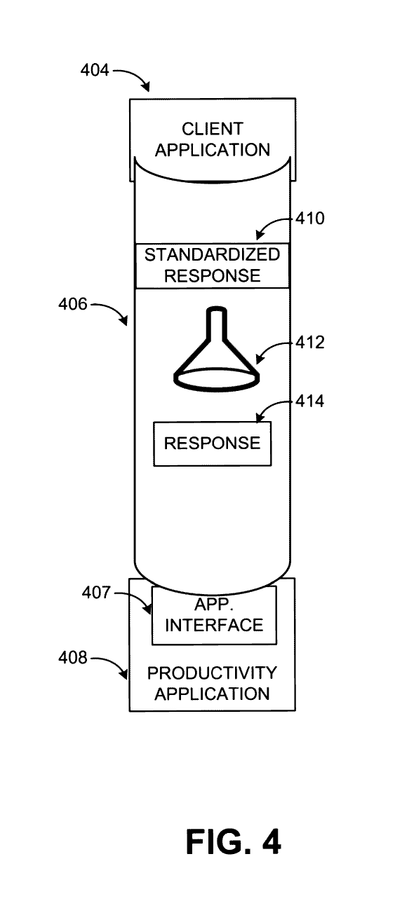

FIG. 4 is a display diagram illustrating an example of processing a response with a pipeline for a unified service and client interface, according to embodiments.

In a diagram 400, a productivity application 408 may communicate an initial response 414 to a client request through a pipeline 406. The productivity application 408 may generate the initial response and deliver the initial response through application interface 407. The pipeline 406 may process the initial response 414 with a standard 412 into a form that may be interpreted by the client application 404. A standardized response 410 processed with the standard 412 may be delivered to the client application 404.

The standard 412 may include a formatting standard. A common formatting standard (such as extensible markup language) may be utilized by a variety of client applications. As such, processing the initial response 414 with a common standard may allow the pipeline 406 to provide a standardized response 410 to a variety of client applications that may execute in a variety of platforms. Examples may include providing the standardized response 410 to a client application that may execute in a mobile platform, in a desktop environment, or in a web based environment, among others.

As discussed above, the application may be employed to perform operations associated with providing a pipeline for unified service and client interface. An increased user efficiency with the productivity application 108 may occur as a result of applying a serialization scheme to a client request to remove platform specific instructions from the client request. Additionally, the productivity application 108 may provide standardized responses to tailor a response to a client application that may execute in a variety of platforms. These operations may reduce processor load, increase processing speed, conserve memory, and reduce network bandwidth usage.

Embodiments, as described herein, address a need that arises from a lack of efficiency between the user 101 interacting with a client application to perform tasks with the productivity application 108 which may execute in a physical server or a computing device. The actions/operations described herein are not a mere use of a computer, but address results of a system that is a direct consequence of software used as a service offenred in conjunction with large numbers of users and applications.

The example scenarios and schemas in FIG. 1 through 4 are shown with specific components, data types, and configurations. Embodiments are not limited to systems according to these example configurations. Providing a pipeline for a unified service and a client interface may be implemented in configurations employing fewer or additional components in applications and user interfaces. Furthermore, the example schema and components shown in FIG. 1 through 4 and their subcomponents may be implemented in a similar manner with other values using the principles described herein.

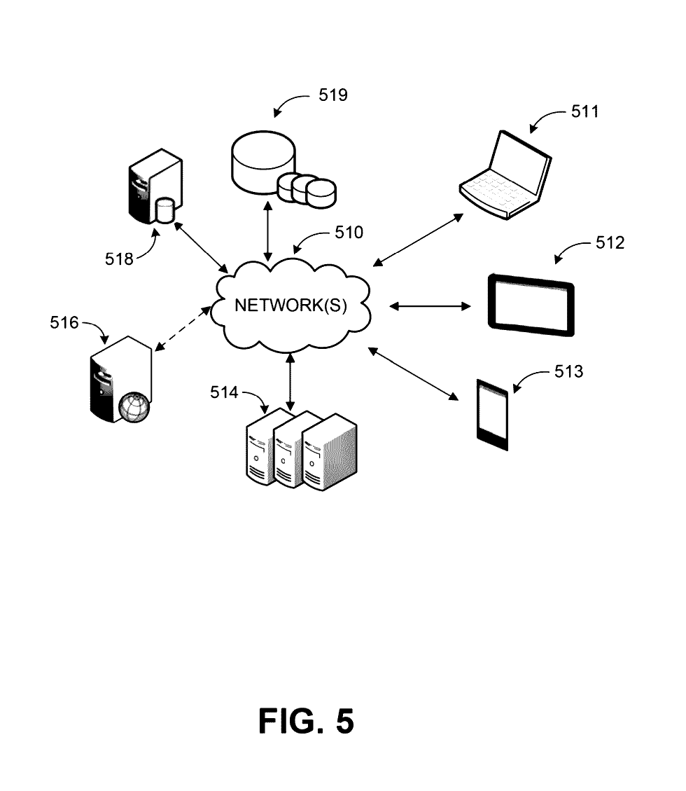

FIG. 5 is an example networked environment, where embodiments may be implemented. A productivity application configured to provide a unified service and client interface may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A productivity application may construct a pipeline based on a shared code base with another productivity application. The pipeline may facilitate a communication between a client application and an interface of the productivity application. A received client request may be processed to construct a serialized request. The serialized request may be transmitted to the interface of the productivity application. An initial response to the serialized request may be received and processed to construct a standardized response. Subsequently, the standardized response may be transmitted to the client application. The productivity application may store data associated with a client request or a response in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a pipeline for unified service and client interface. Furthermore, the networked environments discussed in FIG. 5 are for illustration purposes only. Embodiments are not limited to the example applications, modules, or processes.

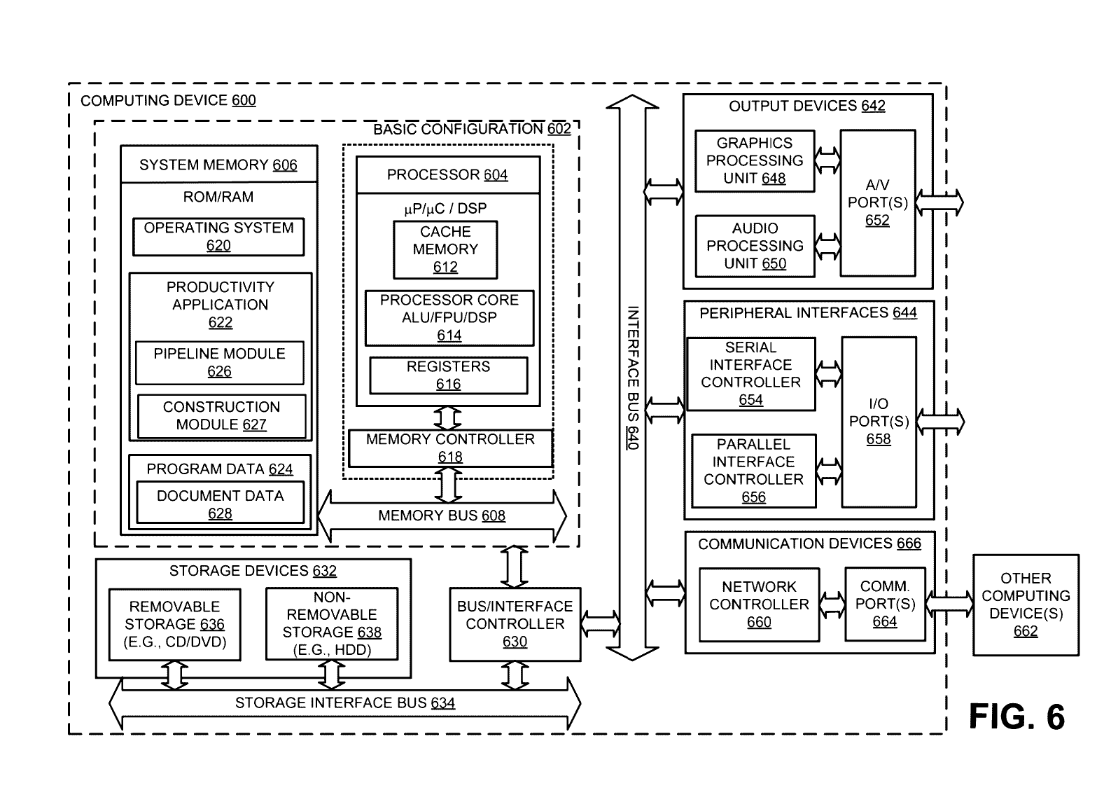

FIG. 6 is a block diagram of an example computing device, which may be used to provide a pipeline for unified service and client interface.

For example, computing device 600 may be used as a physical server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a productivity application 622, and a program data 624. The productivity application 622 may include a component such as a pipeline 626 and a construction module 627. The pipeline 626 and the construction module 627 may execute the processes associated with the productivity application 622. The construction module 627 may construct a pipeline based on a shared code base with another productivity application. The pipeline 626 may facilitate a communication between a client application and an interface of the productivity application. A received client request may be processed to construct a serialized request by the pipeline 626. The serialized request may be transmitted to the interface of the productivity application. An initial response to the serialized request may be received and processed to construct a standardized response. Subsequently, the standardized response may be transmitted to the client application.

The productivity application 622 may receive and transmit requests and responses through a networking device associated with the computing device 600. An example of the networking device may include a hardware networking card that communicatively couples the computing device 600 with a network. The program data 624 may also include, among other data, document data 628, or the like, as described herein. The document data 628 may include a client request and a response, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more L/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide a pipeline for unified service and client interfaces. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

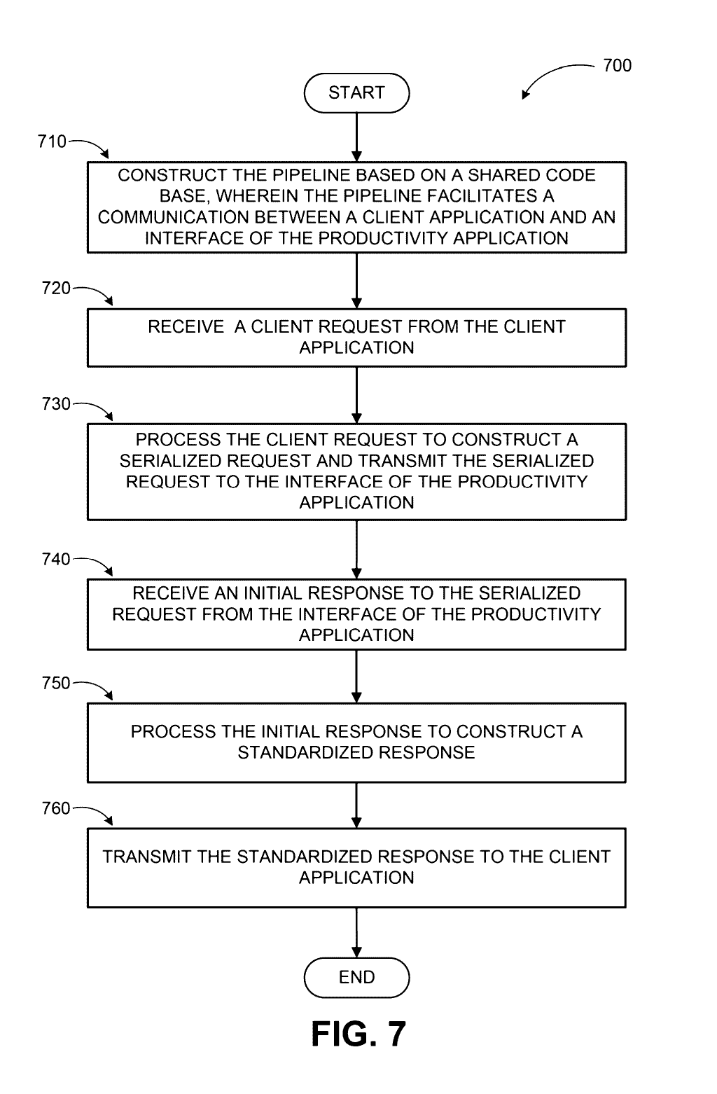

FIG. 7 a logic flow diagram illustrating a process for providing a pipeline for a unified service and a client interface, according to embodiments. Process 700 may be implemented on a computing device such as the computing device 600 or other system.

Process 700 begins with operation 710, where a pipeline based on a shared code base may be constructed. The pipeline may facilitate a communication between a client application and an interface of a productivity application. At operation 720, a client request may be received from the client. The client request may include platform specific instructions.

At operation 730, the client request may be processed to construct a serialized request and transmit the serialized request to the interface of the productivity application. A serialization scheme applied by the pipeline may remove the platform specific instructions from the client request.

At operation 740, an initial response to the serialized request may be received from the interface of the productivity application. At operation 750, the initial response may be processed to construct a standardized response. The standardized response may be interpreted by a number of clients executing on a number of platforms. At operation 760, the standardized response may be transmitted to the client application.

The operations included in process 700 are for illustration purposes. Providing a pipeline for a unified service and client interface may be implemented by similar processes with fewer or additional steps, as well as in different order of operations using the principles described herein.

According to some examples, a computing device for a pipeline for a unified service and client interface may be described. The computing device includes a networking device, a memory configured to store instructions associated with a productivity application, one or more processors coupled to the memory and the networking device. The one or more processors execute the productivity application in conjunction with the instructions stored in the memory. The productivity application includes a construction module and the pipeline. The construction module is configured to construct the pipeline based on a shared code base, where the pipeline facilitates a communication between a client application and an interface of the productivity application. The pipeline is configured to receive, by the networking device, a client request from the client application, process the client request to construct a serialized request and transmit the serialized request to the interface of the productivity application, receive an initial response to the serialized request from the interface of the productivity application, process the initial response to construct a standardized response, and transmit, by the networking device, the standardized response to the client application.

According to other examples, the construction module is further configured to provide the pipeline to another productivity application to allow the other productivity application to facilitate a communication between another client application and the other productivity application, where the other productivity application includes the shared code base. An execution platform of the productivity application differs from an execution platform of the other productivity application. The construction module is further configured to automate a construction of the pipeline by generating instructions associated with the pipeline with a service object structure.

According to further examples, the pipeline is further configured to remove platform specific instructions within the client request through a serialization scheme to construct the serialized request from the client request. The pipeline is further configured to process the initial response with a shared standard to generate the standardized response. The standardized response is interpreted by the client application based on the shared standard. The pipeline is further configured to receive the client request that includes a batch of one or more commands and prepare the batch of the one or more commands for asynchronous executions while constructing the serialized request from the batch of the one or more commands.

According to other examples, the pipeline is further configured to apply a convention to one or more of: an address of a local source and an address of an external source identified in the client request to remove a platform specific address from one or more of: the address of the local source and the address of the external source. The productivity application include one or more of a spreadsheet processing application and a data store processing application. The pipeline is generated during an execution of the productivity application.

According to some examples, a method executed on a computing device for providing a pipeline for a unified service and client interface may be described. The method includes constructing the pipeline based on a shared code base, where the pipeline facilitates a communication between a client application and an interface of a productivity application and instructions associated with the pipeline are generated with a service object structure during an execution of the productivity application, receiving a client request from the client application, processing the client request to construct a serialized request and transmit the serialized request to the interface of the productivity application, receiving an initial response to the serialized request from the interface of the productivity application, processing the initial response to construct a standardized response, and transmitting the standardized response to the client application.

According to other examples, the method further includes processing the client request to identify one or more asynchronous instructions, generating threads for each of the one or more asynchronous instructions, and executing the threads synchronously. The method further includes processing the client request to identify one or more asynchronous instructions, generating threads for each of the one or more asynchronous instructions, executing the threads synchronously. The method further includes generating an abstract syntax tree from instructions of the client request, where the abstract syntax tree includes a tree shaped structure that includes a representation of a syntactical construction of the client request, and generating a control flow graph from the abstract syntax tree, where the control flow graph includes probable execution paths of the client request. The method further includes processing nodes of the control graph to identify one or more entities labeled with an execute statement, annotating the identified entities in the control flow graph to remove the execute statement, and constructing the serialized request from the annotated control flow graph and the abstract syntax tree. The method further includes processing nodes of the control flow graph to identify one or more entities labeled with a load statement, where the load statement causes an execution of a load operation associated with the identified entities during an execution of the client request, annotating the identified entities in the control flow graph to remove the load statement, and constructing the serialized request from the annotated control flow graph and the abstract syntax tree.

According to some examples, a computer-readable memory device with instructions stored thereon to provide a pipeline for a unified service and client interface may be described. The instructions may include actions similar to the actions of the method described above.

According to some examples, a means to provide a pipeline for a unified service and client interface may be described. The means to provide a pipeline for a unified service and client interface may include a means to construct the pipeline based on a shared code base, where the pipeline facilitates a communication between a client application and an interface of the productivity application, a means to receive a client request from the client application, a means to process the client request to construct a serialized request and transmit the serialized request to the interface of the productivity application, a means to receive an initial response to the serialized request from the interface of the productivity application, a means to process the initial response to construct a standardized response and a means to transmit the standardized response to the client application.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for providing a pipeline for a unified service and client interface, the computing device comprising:
a networking device;
a memory configured to store instructions associated with a productivity application;
one or more processors coupled to the memory and the networking device, the one or more processors executing the productivity application in conjunction with the instructions stored in the memory, wherein the productivity application includes:
a construction module configured to:
construct the pipeline based on a shared code base, wherein the pipeline facilitates a communication between a client application and an interface of the productivity application;
the pipeline configured to:
receive, by the networking device, a client request from the client application;
process the client request to construct a serialized request and transmit the serialized request to the interface of the productivity application;
receive an initial response to the serialized request from the interface of the productivity application;
process the initial response to construct a standardized response; and
transmit, by the networking device, the standardized response to the client application.

2. The computing device of claim 1, wherein the construction module is further configured to:
provide the pipeline to another productivity application to allow the other productivity application to facilitate a communication between another client application and the other productivity application, wherein the other productivity application includes the shared code base.

3. The computing device of claim 2, wherein an execution platform of the productivity application differs from an execution platform of the other productivity application.

4. The computing device of claim 1, wherein the construction module is further configured to:
automate a construction of the pipeline by generating instructions associated with the pipeline with a service object structure.

5. The computing device of claim 1, wherein the pipeline is further configured to:
remove platform specific instructions within the client request through a serialization scheme to construct the serialized request from the client request.

6. The computing device of claim 1, wherein the pipeline is further configured to:
process the initial response with a shared standard to generate the standardized response.

7. The computing device of claim 6, wherein the standardized response is interpreted by the client application based on the shared standard.

8. The computing device of claim 1, wherein the pipeline is further configured to:
receive the client request that includes a batch of one or more commands; and
prepare the batch of the one or more commands for asynchronous executions while constructing the serialized request from the batch of the one or more commands.

9. The computing device of claim 1, wherein the pipeline is further configured to:
apply a convention to one or more of: an address of a local source and an address of an external source identified in the client request to remove a platform specific address from one or more of: the address of the local source and the address of the external source.

10. The computing device of claim 1, wherein the productivity application include one or more of: a spreadsheet processing application and a data store processing application.

11. The computing device of claim 1, wherein the pipeline is generated during an execution of the productivity application.

12. A method executed on a computing device for providing a pipeline for a unified service and client interface, the method comprising:
constructing the pipeline based on a shared code base, wherein the pipeline facilitates a communication between a client application and an interface of a productivity application and instructions associated with the pipeline are generated with a service object structure during an execution of the productivity application;
receiving a client request from the client application;
processing the client request to construct a serialized request and transmit the serialized request to the interface of the productivity application;
receiving an initial response to the serialized request from the interface of the productivity application;
processing the initial response to construct a standardized response; and
transmitting the standardized response to the client application.

13. The method of claim 12, further comprising:
processing the client request to identify one or more asynchronous instructions.

14. The method of claim 13, further comprising:
generating threads for each of the one or more asynchronous instructions; and
executing the threads synchronously.

15. The method of claim 12, further comprising:
generating an abstract syntax tree from instructions of the client request, wherein the abstract syntax tree includes a tree shaped structure that includes a representation of a syntactical construction of the client request; and
generating a control flow graph from the abstract syntax tree, wherein the control flow graph includes probable execution paths of the client request.

16. The method of claim 15, further comprising:
processing nodes of the control flow graph to identify one or more entities labeled with a load statement, wherein the load statement causes an execution of a load operation associated with the identified entities during an execution of the client request;
annotating the identified entities in the control flow graph to remove the load statement; and
constructing the serialized request from the annotated control flow graph and the abstract syntax tree.

17. The method of claim 15, further comprising:
processing nodes of the control graph to identify one or more entities labeled with an execute statement;
annotating the identified entities in the control flow graph to remove the execute statement; and
constructing the serialized request from the annotated control flow graph and the abstract syntax tree.

18. A computer-readable memory device with instructions stored thereon for providing a pipeline for a unified service and client interface, the instructions comprising:
constructing the pipeline based on a shared code base, wherein the pipeline facilitates a communication between a client application and an interface of a productivity application and instructions associated the pipeline are generated with a service object structure during an execution of the productivity application;
receiving a client request from the client application;
processing the client request to construct a serialized request and transmit the serialized request to the interface of the productivity application;
receiving an initial response to the serialized request from the interface of the productivity application;
processing the initial response to construct a standardized response; and
transmitting the standardized response to the client application.

19. The computer-readable memory device of claim 18, wherein the instructions further comprise:
providing the pipeline to another productivity application to allow the other productivity application to facilitate a communication between another client application and the other productivity application, wherein the other productivity application includes the shared code base and an execution platform of the productivity application differs from an execution platform of the other productivity application.

20. The computer-readable memory device of claim 18, wherein the instructions further comprise:
processing the client request to identify one or more asynchronous instructions;
generating threads for each of the one or more asynchronous instructions; and
executing the threads asynchronously.
